(19) United States
(12) Patent Application Publication
(10) Pub. No.: US 2004/0078346 A1
(43) Pub. Date: Apr. 22, 2004

(54) Return delivery charges weight averaging system

(76) Inventors: Thomas M Amonette, Greenfield, IN (US); Lawrence J Dasenbrock, Cincinnati (FR); Linda A Deaktor, Berkley, CA (US); Rodney N Dozler, Yatesville, GA (US); Harry L Misener, Bedford, NH (US); David M Stachovitz, West Minster, CA (US); Michael M Strand, Arlington, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/450,467

(22) PCT Filed: May 30, 2001
(86) PCT No.: PCT/US01/17486

(30) Foreign Application Priority Data
Dec. 15, 2000 (US) 60255607

(51) Int. Cl. G06F 17/00

(52) U.S. Cl. 705/407; 705/409; 705/401

(57) ABSTRACT

A method, apparatus, and article of manufacture for determining return delivery charges is described. In one aspect related to the invention, the return delivery charges is determined on the basis of a cost factor (5A). The weight cost factor is determined for a sample of a shipment. The weight cost factor is then utilized to determine the return delivery charges for the shipment (5B).

### DESCRIPTION OF THE INVENTION

This application is based upon and claims the benefit of priority from U.S. Provisional Application No. 60/255,607 by Thomas M. Amonette et al., filed Dec. 15, 2000, the contents of which are expressly incorporated herein by reference.

### FIELD OF THE INVENTION

The present invention relates to a system for determining the return delivery charges for mail that has been returned.

### BACKGROUND OF THE INVENTION

FIG. 1 depicts an example delivery and return system. A customer 102 places an order 104 (e.g., makes a purchase) which is processed at a business 106. The business sends a package containing the item(s) ordered 108 to delivery terminal, such as a Post Office 110, and the package is delivered to customer 102. Customer 102 may then want to return the package. For example, customer 102 may not be satisfied with the order or may not receive what he or she intended. Customer 102, with or without opening the package, may take the package back to Post Office 110, and Post Office 110 will return the package containing the item(s) ordered 108 to business 106.

Businesses can receive hundreds of return packages every day, as described in FIG. 1 and above. In conventional systems, it is cost-prohibitive for the business to pay in advance for return delivery charges, such as return postage, on every item sent out, and therefore the business only pays for postage on return items. To determine the amount of postage owed by the business for the processing of the return, the Post Office individually weighs each package being returned to the business to determine how much postage to charge the business for each package.

FIG. 2A depicts a conventional system for handling returns in which return delivery charges are increased. Post Office 110 receives a plurality of packages such as packages 1, 2, 3, and 4 to be returned to business 106. For ease of handling, packages 1, 2, 3, and 4 may be kept in a container 202 (e.g., a mail tray or cart) corresponding to business 106. However, to determine the return delivery charge for the packages in today's systems, the delivery terminal, such as Post Office 110, removes each package from container 202 and weighs the package to determine the return delivery charge. The charge for each package 1, 2, 3, and 4 will be added together to calculate the total return delivery charge for the return of packages 1, 2, 3, and 4.

It is very time consuming and costly for a delivery terminal to process each package, one at a time, before returning a large quantity of packages to the customer and then charging the business for the return delivery charges. With conventional systems, a delivery terminal spends a tremendous amount of time and money processing returned packages.

### SUMMARY OF THE INVENTION

In accordance with present invention, certain aspects are related to a apparatus, method, and computer readable medium for determining return delivery charges for a shipment without determining the return delivery charges for item in the mail shipment.

In accordance with one aspect of the present invention, there is provided a method for determining an amount of return delivery charges for a shipment of items, including selecting a portion of the shipment as a sample; determining a total weight of the items in the sample; determining a of the return delivery cost of all items in the sample; determining a cost factor based on the total weight and the total return delivery cost of the sample; determining a total shipment weight of the shipment; and applying the cost factor to the total shipment weight to obtain the return delivery charges for the shipment.

In accordance with another aspect of the present invention, there is provided an apparatus for determining return delivery charges for a shipment of items, including means for selecting a portion of the shipment as a sample; means for determining a total weight of the items in the sample; means for determining a of the return delivery cost of all items in the sample; means for determining a cost factor based on the total weight and the total return delivery cost of the sample; means for determining a total shipment weight of the shipment; and means for applying the cost factor to the total shipment weight to obtain the return delivery charges for the shipment.

In accordance with another aspect of the present invention, there is provided a computer readable medium containing instructions for determining return delivery charges for a shipment of items, the instructions including selecting a portion of the shipment as a sample; determining a total weight of the items in the sample; determining a of the return delivery cost of all items in the sample; determining a cost factor based on the total weight and the total return delivery cost of the sample; determining a total shipment weight of the shipment; and applying the cost factor to the total shipment weight to obtain the return delivery charges for the shipment.

Additional advantages of the invention will be set forth in part in the description which follows, and in part will be obvious from the description, or may be learned by practice of the invention. The objects and advantages of the invention will be realized and attained by means of the elements and combinations particularly pointed out in the appended claims.

### BRIEF DESCRIPTION OF THE DRAWINGS

FIG. 1 is an illustration of an example delivery and return system;

FIG. 2A is an illustration of a conventional system for handling return delivery charges;

FIG. 2B is a high level description of a system for processing return delivery charges more efficiently consistent with certain aspects related to the present invention;

FIGS. 3A, 3B, and 3C are illustrations of how items might arrive at a delivery terminal consistent with certain aspects related to the present invention;

FIGS. 4A, 4B, and 4C are illustrations of exemplary sampling systems consistent with certain aspects related to the present invention;

FIGS. 5A and 5B are illustrations of a return delivery charge weight averaging system consistent with certain aspects related to the present invention;

FIG. 6A is an example of a Container Weights Sheet for use in a Return delivery charge Weight Averaging System consistent with certain aspects related to the present invention;

FIG. 6B is a sample Postage Due Sample Collection Sheet consistent with certain aspects related to the present invention;

FIG. 7A is a Sample Day Selection form consistent with certain aspects related to the present invention;

FIG. 7B is an illustration of a completed Sample Day Selection form consistent with certain aspects related to the present invention;

FIG. 8A is an illustration of a Current Week Data Entry Form consistent with certain aspects related to the present invention;

FIG. 8B is a completed sample of a Current Week Data Entry Form consistent with certain aspects related to the present invention;

FIG. 9A is an exemplary Factor Calculation sheet consistent with certain aspects related to the present invention;

FIG. 9B is an exemplary completed Factor Calculation sheet consistent with certain aspects related to the present invention;

FIG. 10A is an exemplary Postage Due Log consistent with certain aspects related to the present invention;

FIG. 10B is an exemplary completed Postage Due Log consistent with certain aspects related to the present invention;

FIGS. 11A and 11B are exemplary Postage Due Fiscal Year Data Reports consistent with certain aspects related to the present invention.

FIGS. 12A and 12B are exemplary Weekly Postage Due Cost Factor graph and a Weekly Total Net Weights graph, both blank and completed consistent with certain aspects related to the present invention;

FIGS. 13A and 13B are exemplary Weekly Postage Due graph and a Weekly Sample Net Weights graph, both blank and completed consistent with certain aspects related to the present invention.

FIG. 14 is an exemplary postal system for determining the return delivery charge for a shipment consistent with certain aspects related to the present invention.

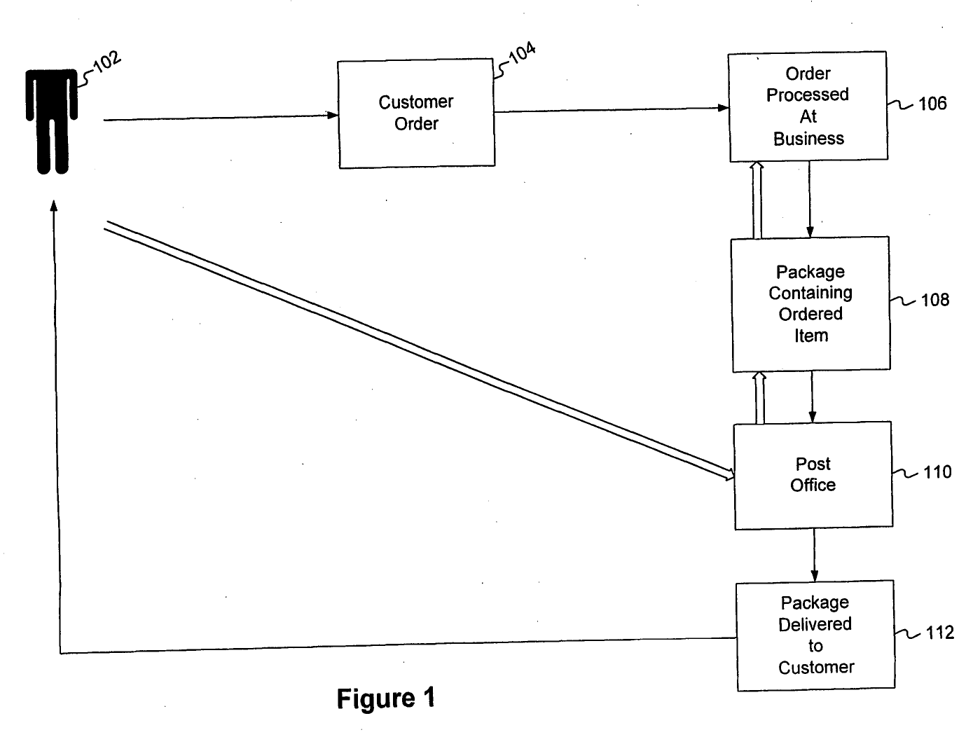

### DESCRIPTION OF THE EMBODIMENTS

It is to be understood that both the foregoing general description and the following detailed description are exemplary and explanatory only and are not restrictive of the invention, as claimed.

Reference will now be made in detail to the present embodiments of the invention, an examples of which are illustrated in the accompanying drawings. Wherever possible, the same reference numbers will be used throughout the drawings to refer to the same or like parts.

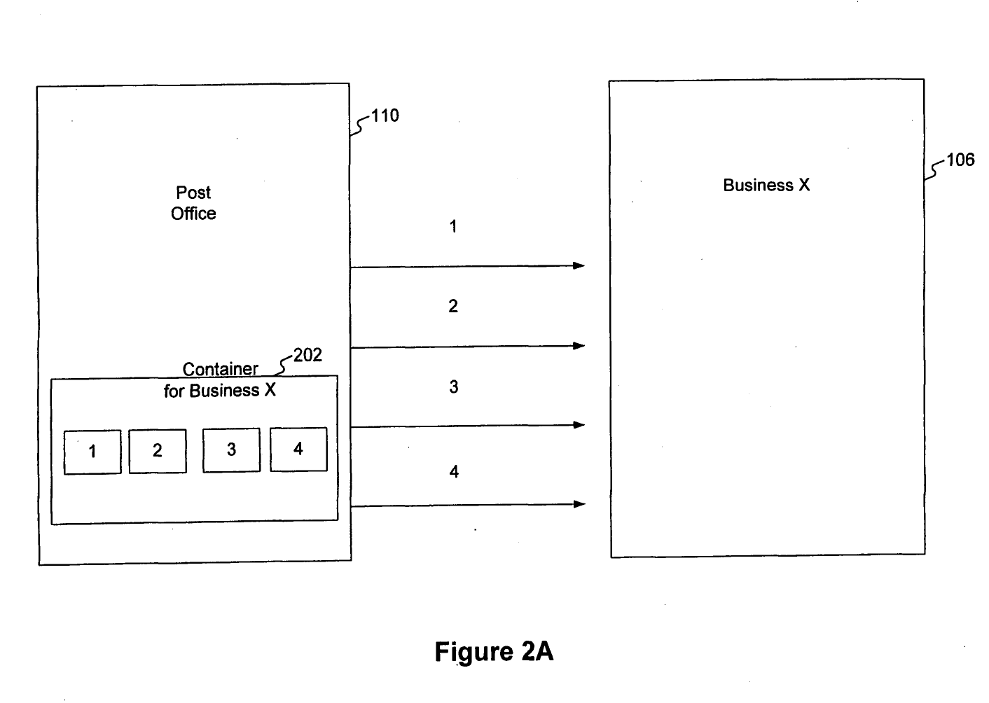

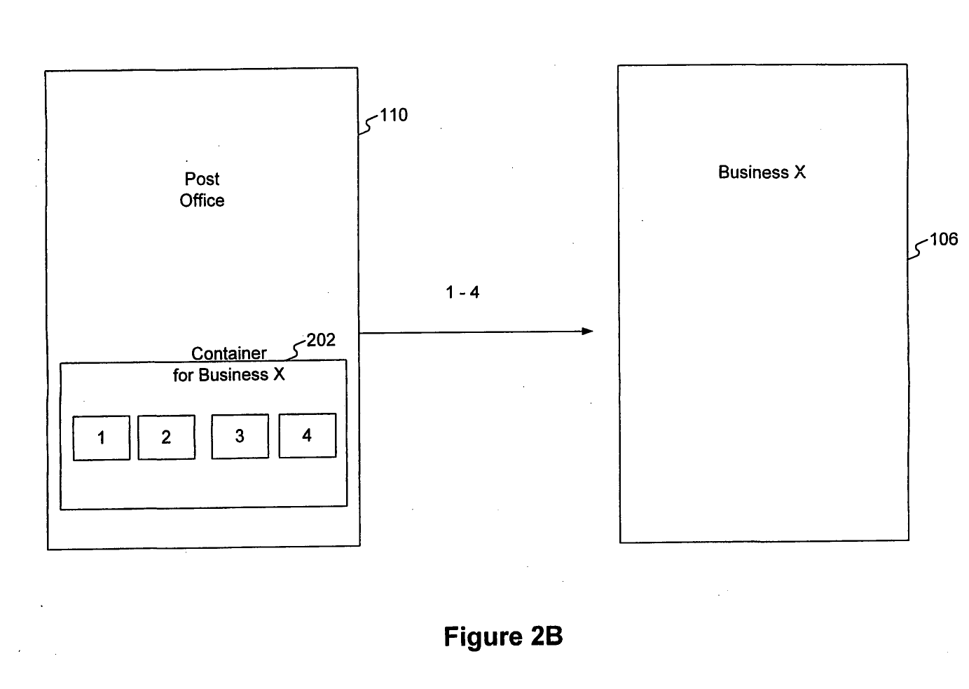

FIG. 2B is a high level description of a system for processing return delivery charges more efficiently consistent with certain aspects related to the present invention. In this system, Post Office 110 receives a plurality of items such as items 1, 2, 3, and 4 to be returned to business 106. For ease of handling, items 1, 2, 3, and 4 may be kept in a container 202 (e.g., a mail tray or cart) corresponding to business 106. Rather than weighing each package individually, as in conventional systems, Post Office 110 can determine the return delivery charges for items 1, 2, 3, and 4 using a weight averaging factor. The weight factor relates the return delivery charges to the weight of the items. In other words, container 202 would be weighed as a unit and a weight averaging factor would be applied to the weight of container 202, less the tare of container 202, including items 1, 2, 3, and 4. Business 106 would be charged the return delivery charges based upon the application of the weight averaging factor against the total container weight, eliminating the individual processing of items 1, 2, 3, and 4.

Container 202 could be any variety of shipping equipment that is mobile and that encloses one or more individual items or packages. For example, container 202 could be a truck, a mail sack, an “Over the Road” mail container, or a Bulk Mail Center container.

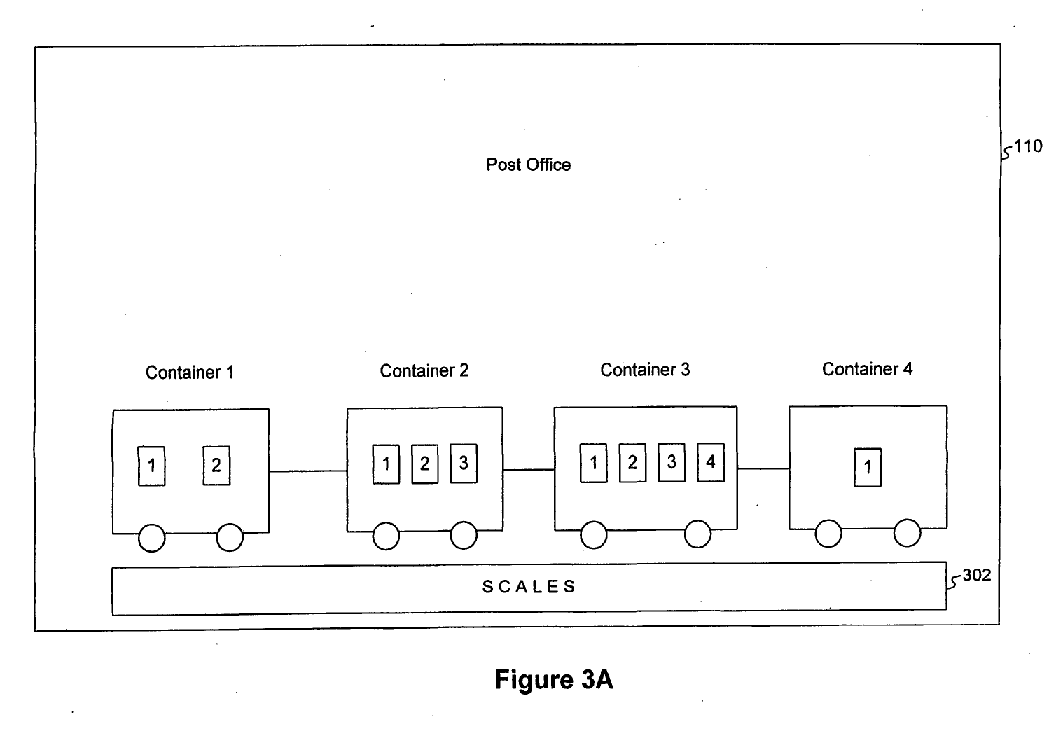

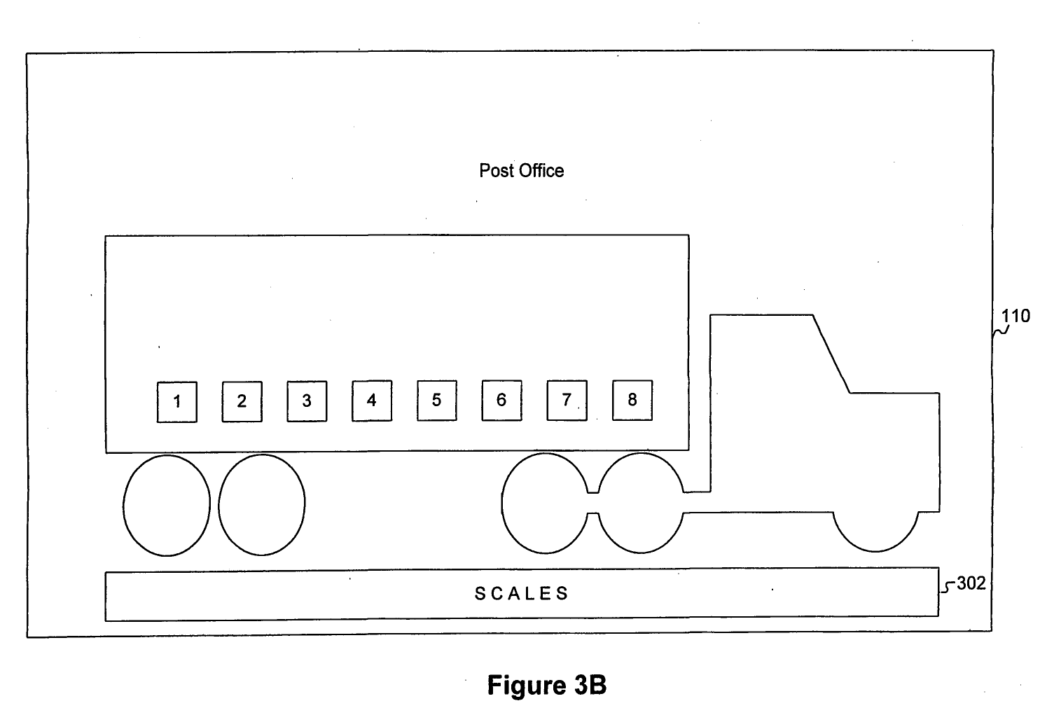

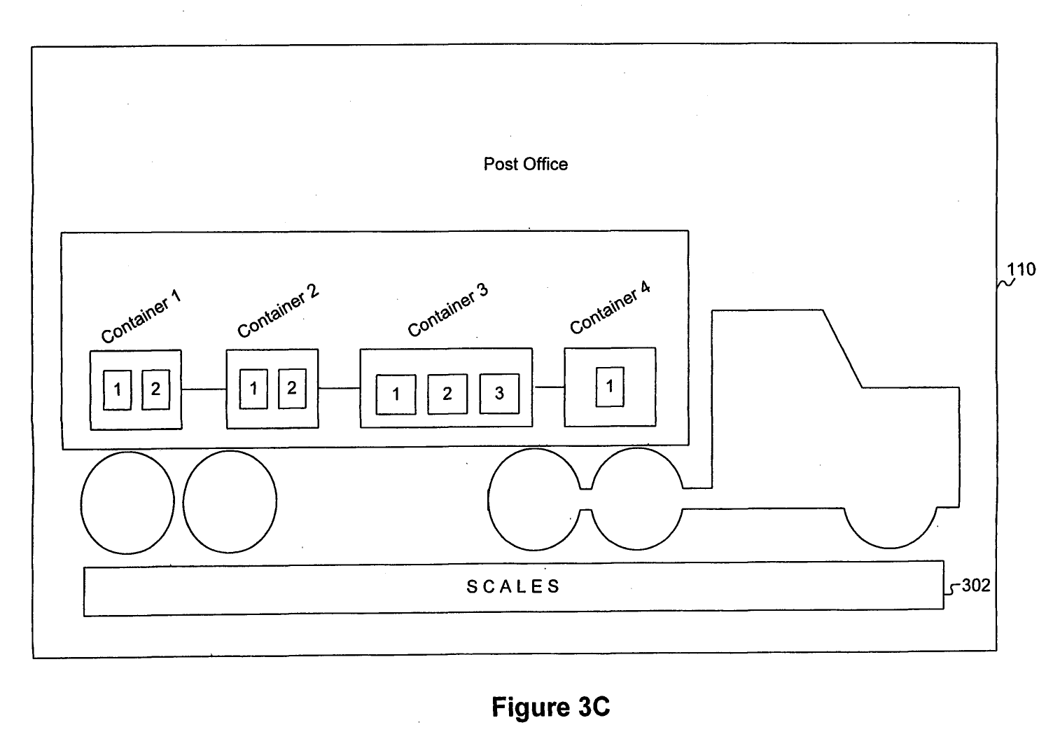

FIGS. 3A, 3B, and 3C illustrate examples of how items might arrive at Post Office 110 consistent with certain aspects related to the present invention. As shown in FIG. 3A, Post Office 110 might receive four containers, such as a series of hitched mail hampers, each containing one or more returned items. In FIG. 3A, container 1 contains two items, container 2 contains three items, container 3 contains four items, and container 4 has a single package. In systems consistent with certain aspects related to the present invention, the entire shipment (i.e., containers 1-4) can be weighed on a scale 302. As illustrated in FIG. 3B, a container received at Post Office 110 could be as large as a truck in which items (i.e., items) may be bed-loaded in the back of the truck, which is weighed on scale 302. FIG. 3C illustrates that a truck might house one or more containers 1-4, each holding one or more items. In this case, the truck, with its cargo, could be weighed on scale 302.

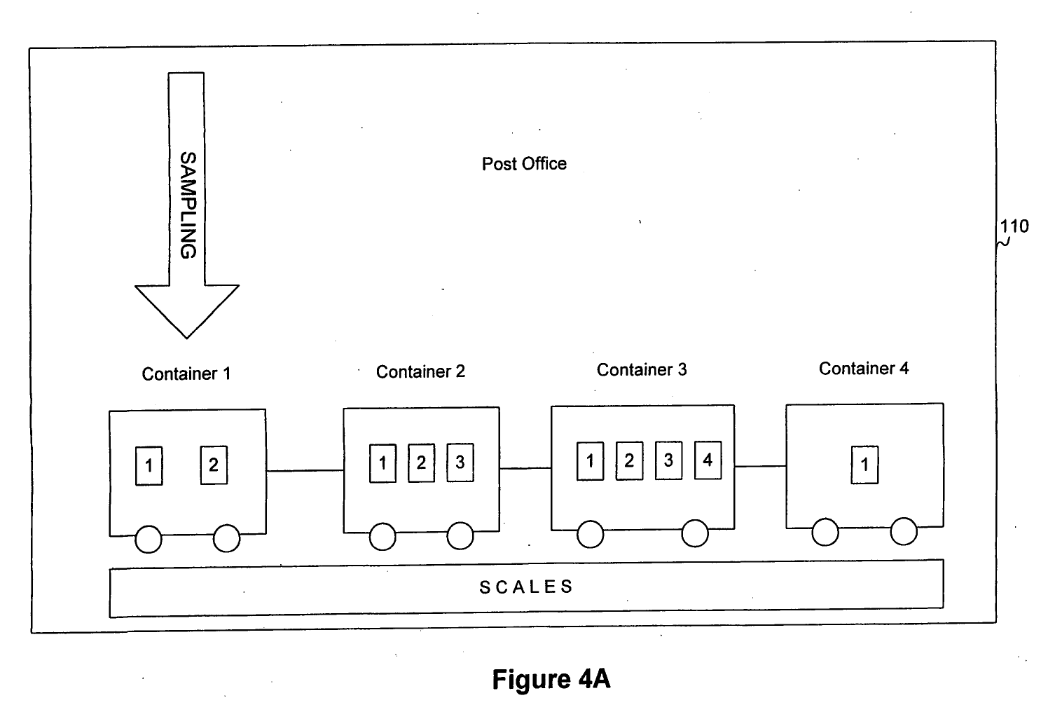

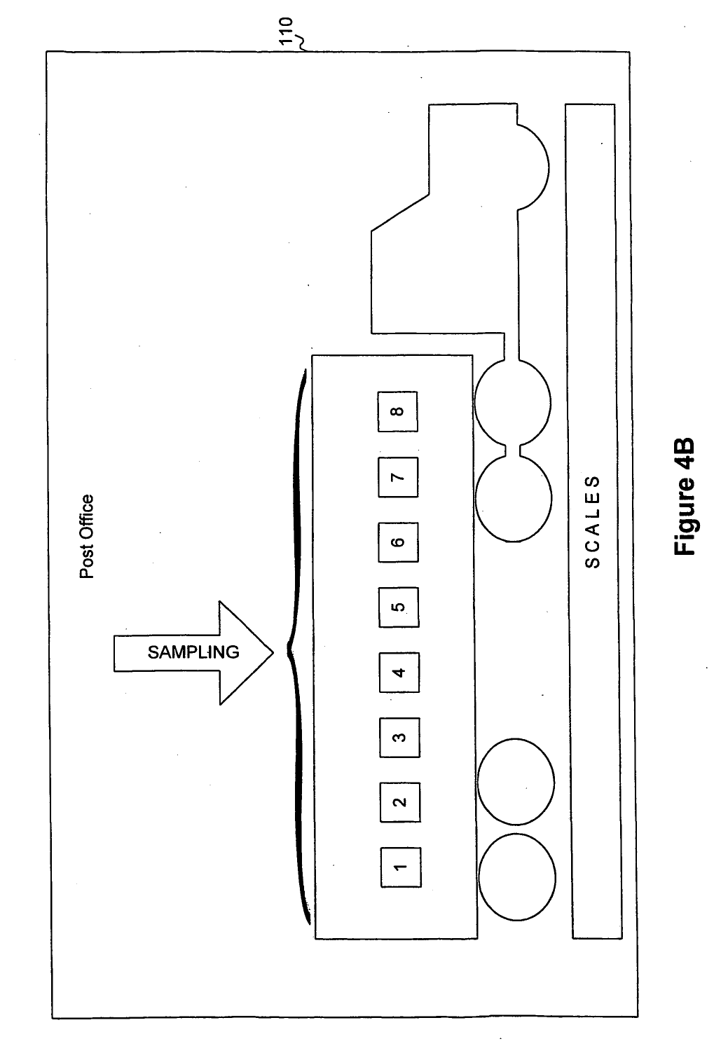

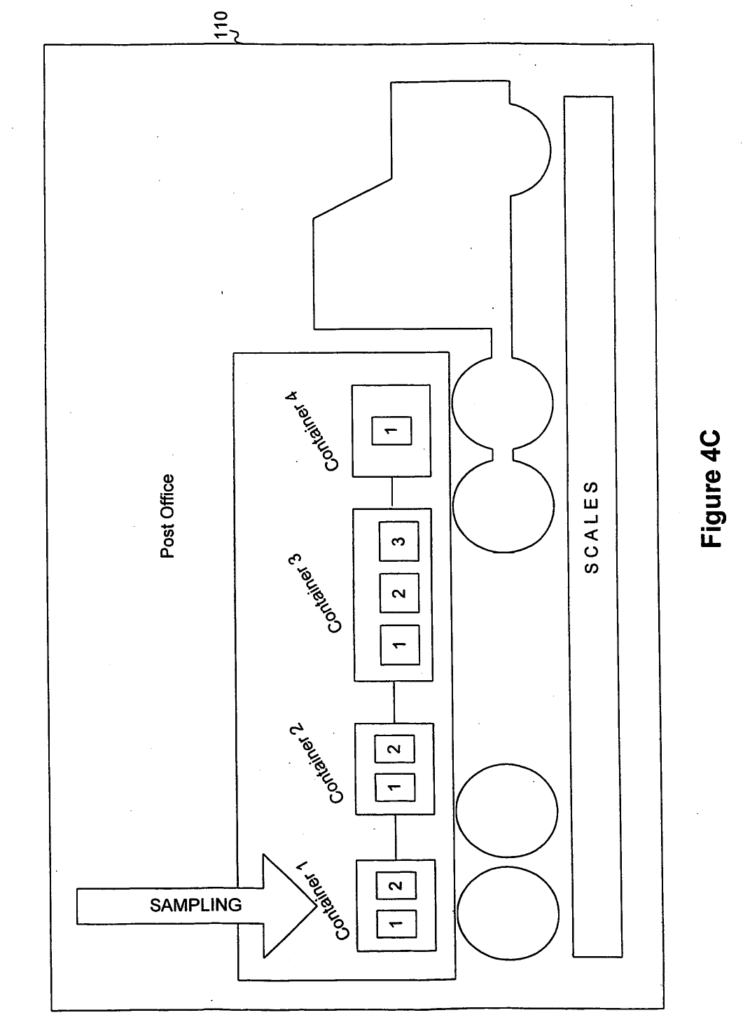

Systems consistent with certain aspects related to the present invention operate based on a total weight of a shipment received, less the tare, as described below, and the return delivery charges for a sample out of the shipment. FIGS. 4A, 4B, and 4C illustrate how this sampling can be done. As shown in FIG. 4A, the shipment consists of items in 4 containers, labeled container 1 through container 4 consistent with certain aspects related to the present invention. The total weight of this shipment is determined as described above. Then, a sample of the shipment is processed to determine the return delivery charges for the items that make up the sample. For example, in FIG. 4A, container 1 would be marked for sampling purposes. In one embodiment, a sample should contain a minimum of a predetermined number of items, e.g. 200. If there are less than 200 items in container 1, then the sampling process would direct that an additional container, e.g., container 2, be added to the sample in order to derive a minimum of 200 items for the sample. In one embodiment, the sample must consist of complete containers only.

FIG. 4B depicts a shipment containing a truck full of items. Considering the truck as a container, the sample would consist of the entire shipment in the container. FIG. 4C shows that the items in the truck could be in containers such as rolling mail carts. For sampling purposes, the individual rolling mail carts would be considered as separate containers, so the sample might consist of only container 1.

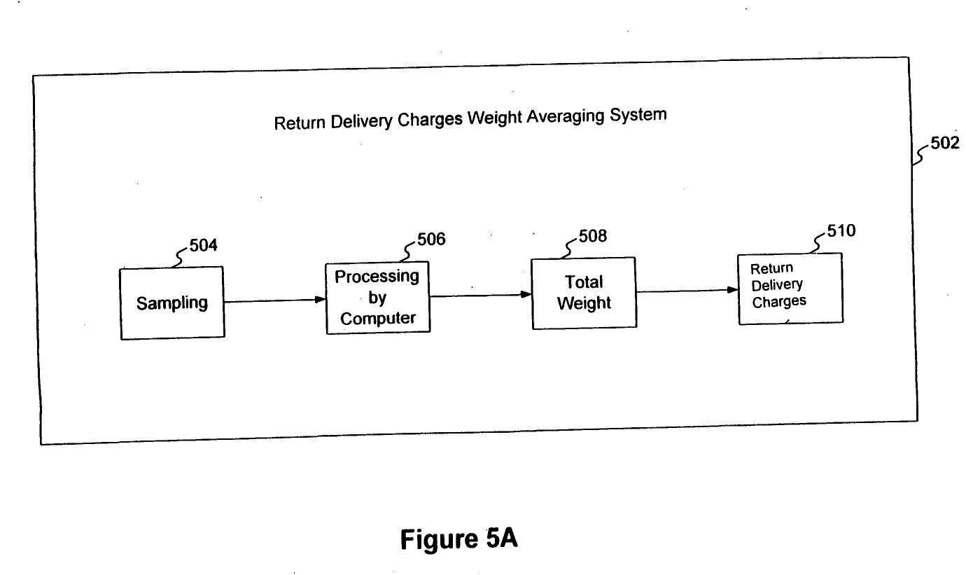

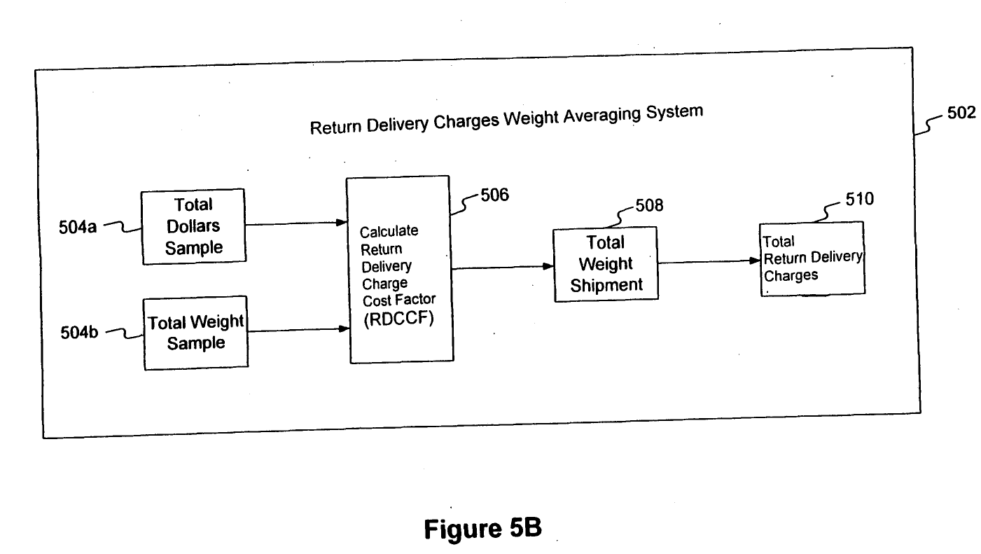

FIG. 5A is a high level flow chart of a return delivery charges weight averaging system consistent with certain aspects related to the present invention. For a shipment of items to be returned to a business, a random sample of the shipment, as described above, is taken (stage 504). Data about this sample, such as weight and category, is input into a computer program which processes the sample data (stage 506). The computer program determines the return delivery charges for the sample and calculates a cost factor. The cost factor is output by the computer program and applied to the total weight of the shipment (stage 508), to determine the return delivery charges for the entire shipment (stage 510).

FIG. 5B shows a return delivery charges weight averaging system consistent with certain aspects related to the present invention, in greater detail. The sample data described in stage 504 helps to determine a cost factor that reflects the profile of the mail being returned to the business. In one embodiment of the present system, the sample data is gathered periodically, such as once per week, to keep the cost factor current. In this embodiment, return delivery charges weight averaging system 502 dictates one day every week to be the sample day. In this embodiment, each day of the week has an equal chance of being selected so that the sample day is chosen at random. Post Office 110 can input into the computer approximately how many containers of mail are expected to be received on each day of the week and system 502 determines the day of the week and the number of containers that will be sampled.

As shown in FIG. 5B, on the sample day of the week, a Post Office clerk will weigh and rate, that is, determines the proper category for calculating a delivery charge for every single item within the sample. The return items in the shipment can be, for example, prepaid items with no return delivery charges or partially paid items or fully unpaid items, that is to say, the customer has returned the item without paying any delivery charge and the company has to pay the return delivery charge on that particular item. Systems consistent with the present invention can process any type of delivery item, including packages, Priority Mail, and standard Parcel Post mail. Therefore, the sample could consist of a variety of different items, different classes of mail, and with different amounts paid or not paid on them. For the sample, the Post Office clerk rates each item to determine the class of mail, assess whatever zone issues exist, and determine the appropriate return rate from the point of origin (i.e., the customer), to the point of destination (i.e., the business).

As each item in the sample is processed, the clerk inputs the return delivery charge into return delivery charge weight averaging system 502 until all containers in the sample are processed, for a minimum of 200 items. In one embodiment, the sample must include full containers. That is, full containers are sampled, so that if a container with only 100 items is designated as the sample by system 502, the clerk would then add another full container to the sample until a minimum of 200 items is reached. In this way, the total dollar amount of the delivery charge 504a for the sample is input into return delivery charge weight averaging system 502.

Also input is a total weight 504b of the sample. The total weight 504b is obtained as described above. For example, each container can be rolled over a scale, and the total weight of the items inside the container is determined by subtracting the tare for the particular container. In other words, if the container is a USPS Over The Road rolling piece of equipment, the known weight for that container, i.e., the tare, is deducted from the total weight to determine the total weight of the sample, i.e., the items only, 504b. To calculate a return delivery charge cost factor (RDCCF) 506, system 502 computes total return delivery charges which have been individually calculated for each item of the sample. This value is then divided by the total sample weight. The RDCCF is applied to the weight 508 of the entire shipment by multiplying the RDCCF by the total weight of the shipment 508, resulting in the total return delivery charges for the shipment 510. In summary, system 502 samples a population of mail with no discrimination or discretion in the selection of the sample. Using the total return delivery charges on the sample 504a and the total weight of the sample 504b, a return delivery charges cost factor 506 is calculated and applied to the total weight of the shipment (less the container tare) 508 to determine the return delivery charges for the shipment 510.

In one embodiment of the present inventions, the RDCCF is a rolling weighted average based on sample data over a series of four weeks. In this way, the RDCCF is adjusted every week. Each week, a sample is processed on one day and the RDCCF is derived and applied against the next week's mail. The RDCCF is applied against the total weight of the shipments for the sample day and the following days until the next sample day. When the next sample day comes (i.e., in the second week), the new sample information is put into return delivery charges weight averaging system 502 and another cost factor is developed and applied for the items that come in until the following week.

Once four consecutive weeks have passed, a month's worth of information is compiled. For the fifth week, the first week's data is dropped to produce a rolling RDCCF. This embodiment produces a fairly accurate picture of the items being returned, including the weight of the items and the return delivery charges for the items. As stated before, this system is applicable to for a variety of different types of items, such as Priority Mail, business reply mail, Standard Mail (B), partially paid mail, and certified mail. The various types of items do not have to be separated-they can all be sampled together. Such a system expedites the return of the inventory to the customer and significantly reduces the cost of returning items associated with weighing and rating every single package.

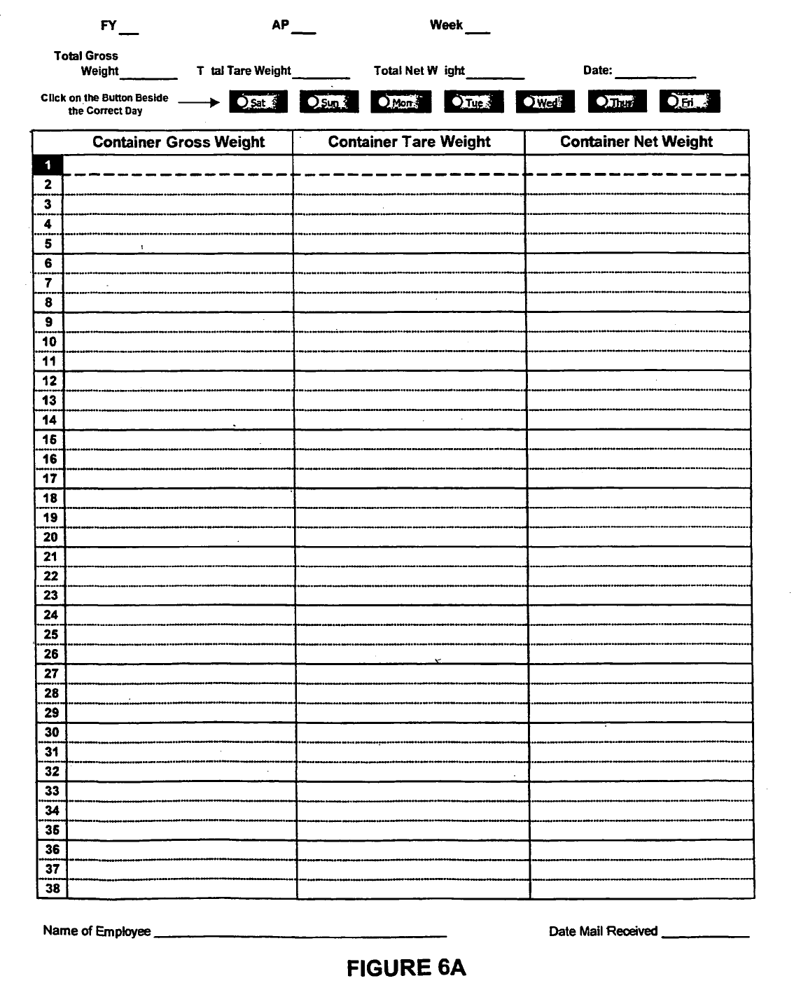

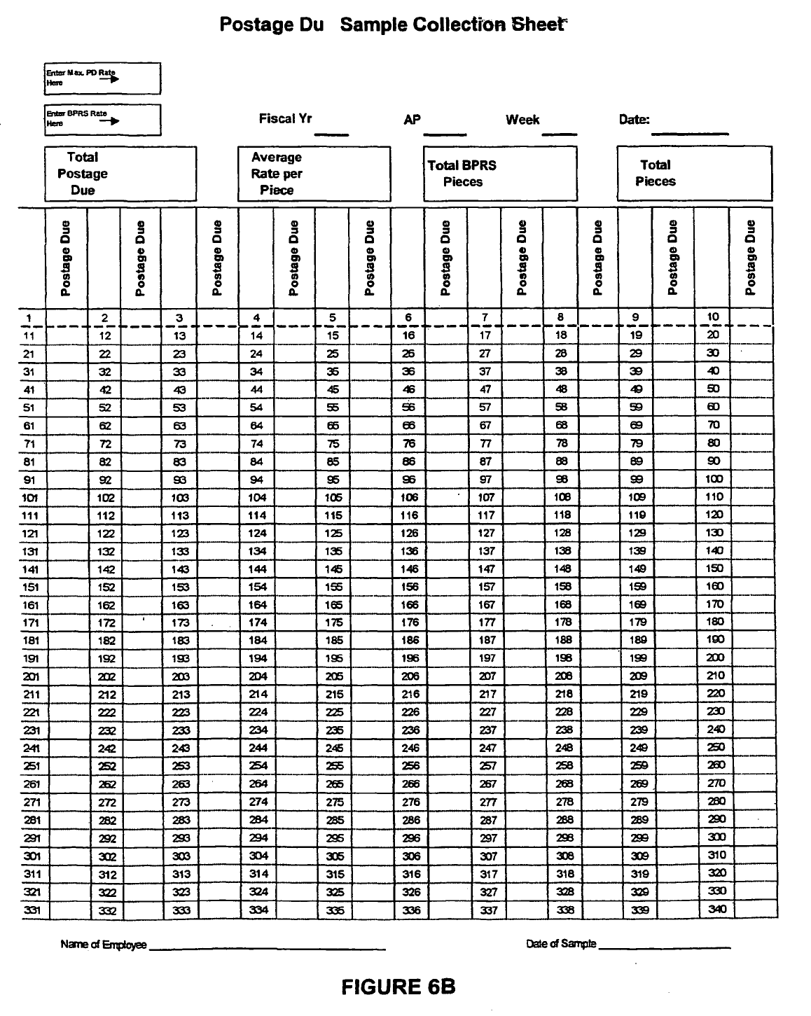

FIG. 6A is an example of a Container Weights Sheet for use in a Return delivery charges Weight Averaging System consistent with certain aspects related to the present invention. Every container received at Post Office 110 is weighed every day in order to assess return delivery charges on the items in the container. The Container Weights Sheet of FIG. 6A includes the container gross weight, i.e., what is rolled over the scale and the container tare weight, i.e., the weight of the metal, fabric, wheels, etc. that make up that particular container. The container tare weight is subtracted from the container gross weight to determine the container net weight, i.e., the weight of the contents of the container. The container net weight is used as described above to calculate the cost factor.

FIG. 6B is a sample Postage Due Sample Collection Sheet consistent with certain aspects related to the present invention. As described above, in one embodiment of the present invention, a sample is processed periodically, such as on one day per week. The Postage Due Weight Averaging System dictates which container(s) will be sampled out of an entire shipment received for a business on the sample day. For each container sampled, every item in the container will be weighed and rated individually by a Post Office clerk individually calculating the postage due for each item. As the clerk weighs and rates each item, the clerk enters the postage due for that item in the Postage Due column shown in FIG. 6B. The Return delivery charges Weight Averaging System will add the postage due for each package to create the Total Postage Due for the sample. The system can also determine an Average Rate Per Item by dividing the Total Postage Due by the total number of items in the sample. Using the Postage Due Sample Collection Sheet, the system also tracks the number of Bulk Parcel Return Service (BPRS) items in the sample. The Return delivery charges Weight Averaging System will keep track of the number of BPRS items because, in some embodiments, a business must receive a minimum number of BPRS items in order to qualify for a lower postage rate. Using the Postage Due Sample Collection Sheet, every item, including BPRS, Priority Mail, Parcel Post, and Standard Mail (B), will be weighed and rated and that information will be entered into the Return delivery charges Weight Averaging System. Although FIG. 6B indicates space for entries related to 340 items, containers may have more or fewer items.

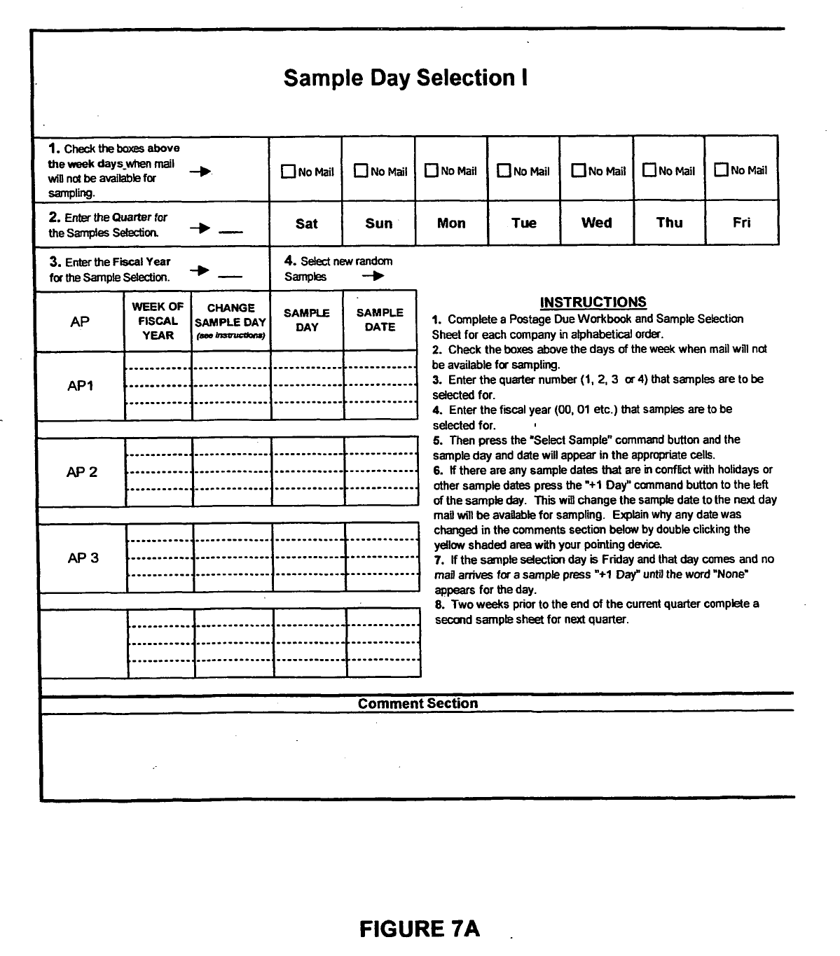

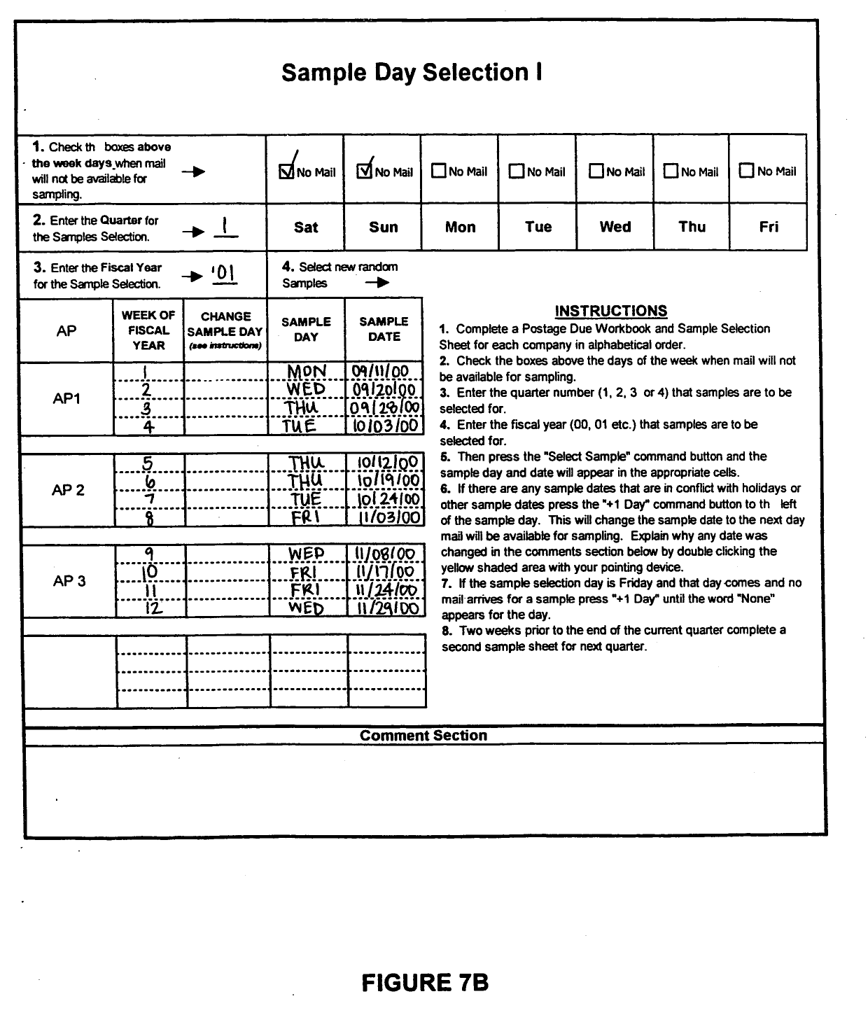

FIG. 7A is Sample Day Selection sheet consistent with certain aspects related to the present invention. On this sheet, a user can input data to indicate the days on which the business does or does not receive mail. The user can also input the fiscal year, the accounting period, and the quarter being tracked. The Return delivery charges Weight Averaging System uses the data to determine sample dates for the business. The system will not select sample dates that are outside the specified accounting periods or quarters. Additionally, the system will not choose a day on which no mail is received by the business as the sample date. For example, if the business does not receive mail on Saturday or Sunday, the user will check the appropriate box on the Sample Day Selection sheet and the system will not choose a Saturday or Sunday as the sample day.

FIG. 7B illustrates a completed Sample Day Selection form consistent with certain aspects related to the present invention. This example shows a mailer that does not receive mail on Saturday or Sunday, which means the Return delivery charges Weight Averaging System will choose to sample mail only on Monday through Friday. In FIG. 7B, the input to the Return delivery charges Weight Averaging System includes the quarter (1) and the fiscal year ('01). Once this information is input, the Return delivery charges Weight Averaging System will automatically select the sample days and the sample dates for the accounting periods (APs) corresponding to the first quarter of fiscal year '01.

Systems consistent with certain aspects related to the present invention can adjust to accommodate federal holidays, i.e., days when mail is not delivered. For example, if the Return delivery charges Weight Averaging System indicates that sampling will take place on Thanksgiving Day, the user can input a “Plus 1” command which will direct the system to adjust the sample day to the next day on which mail will be available for sampling.

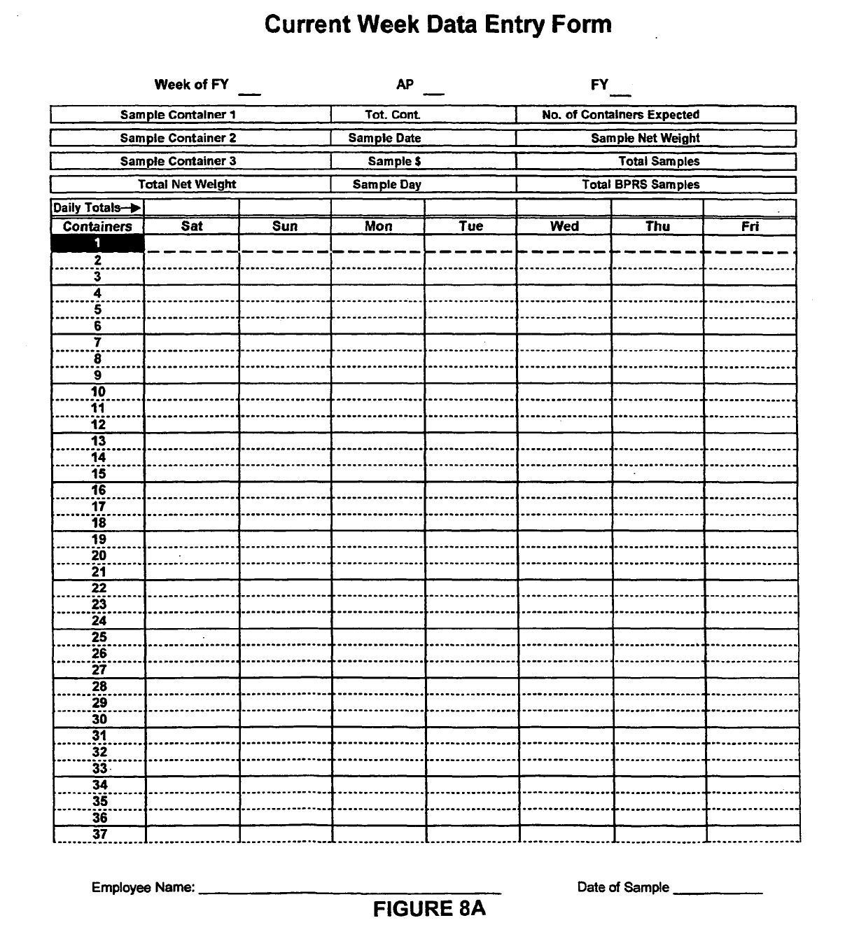

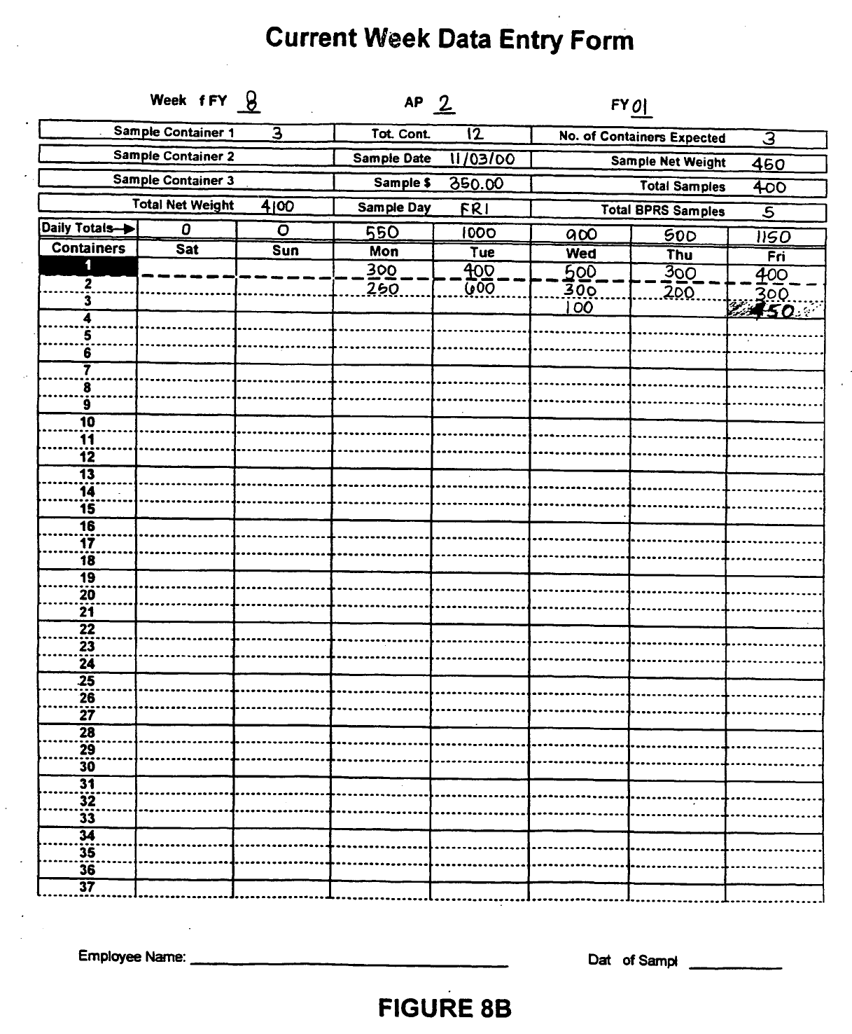

FIG. 8A is an illustration of a Current Week Data Entry Form consistent with certain aspects related to the present invention. Data is input using this form and collected by the Return delivery charges Weight Averaging System, arranged by, for example, the week of the fiscal year (FY), the accounting period (AP) and the fiscal year. To use this form, the Return delivery charges Weight Averaging System will shade under the container column how many containers are to be sampled. Based upon the Sample Day Selection sheet shown in FIGS. 7A and 7B, the system will shade the day of the week that was selected as the sample day. For the sample container(s), this sheet is used to collate one week's sample information including the total net weight of the sample container(s), total postage due for the sample, and the total of the Bulk Parcel Return Service (BPRS) items.

FIG. 8B is a completed example of a Current Week Data Entry Form consistent with certain aspects related to the present invention. As shown therein, the user has indicated to the Return delivery charges Weight Averaging System that three containers are expected on the sample date of Nov. 3, 2000, a Friday. The Return delivery charges Weight Averaging System shows, in the first sample container column in FIG. 8B, that the container to be used for the sample will be container number 3. The Return delivery charges Weight Averaging System will shade Friday (i.e., the sample day) and the third box (i.e., corresponding to the sample container). which will tell us that is the container that has been selected by the Return delivery charges Weight Averaging System for us to sample.

As shown in FIG. 8B, the example business does not get mail on Saturday and Sunday (indicated by data input earlier). For this business, on Monday two containers were received, one weighing 300 pounds and one weighing 250 pounds for a total of 550 pounds (i.e., the contents of the containers weighed 550 pounds total; the tare weight of the containers themselves is subtracted as described above). On Tuesday, two containers were received, one weighing 400 pounds and one weighing 600 pounds, for a total of 1000 pounds. On Wednesday, three containers were received, one weighing 500 pounds, one weighing 300 pounds, and one weighing 100 pounds, for a total weight of 900 pounds. On Thursday, two containers were received, one weighing 300 pounds and one weighing 200 pounds, for a total of 500 pounds. On Friday, which is the day designated for sampling, 3 containers were received, one weighing 400 pounds, one weighing 300 pounds, and the container that was selected for sampling (i.e., container 3) weighing 450 pounds.

The sample container, container 3 on Friday, had 400 samples, or items, for a total of 450 pounds. As explained above, each of the 400 items will be individually weighed and rated to determine how much postage is due. Also included in the sample were five Bulk Parcel Return Service (BPRS) items. The example of FIG. 8B contains a week's worth of data and shown that $350.00 postage due was individually calculated on Friday, November 3 for the sample container 3 that weighed 450 pounds and consisted of 400 samples including five BPRS samples. In one embodiment of the present invention, the Current Week Data Entry Form is used to accumulate information for four weeks before calculating a cost factor for new businesses.

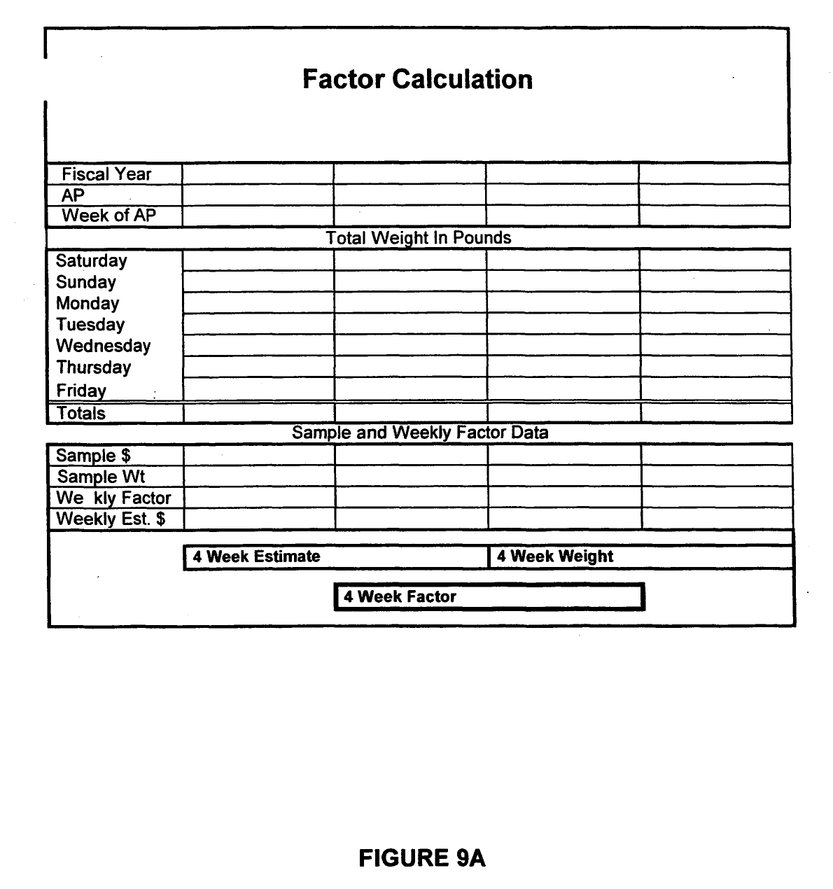

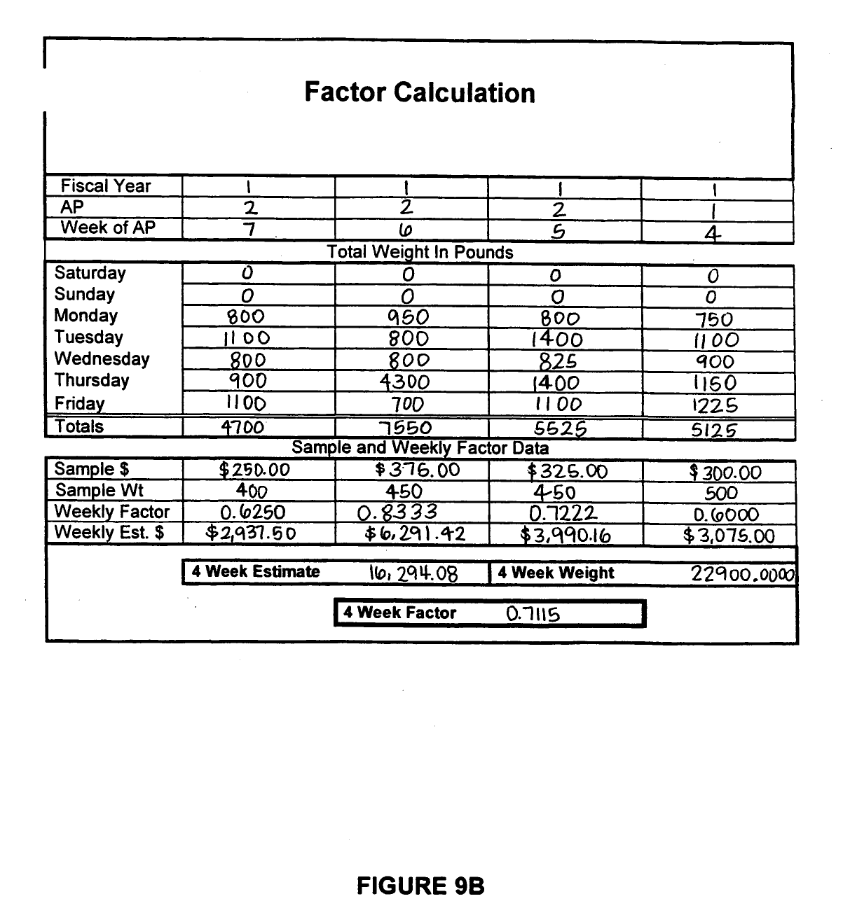

FIG. 9A is a Factor Calculation sheet consistent with certain aspects related to the present invention which includes the fiscal year, the particular accounting period (AP), and the week of the accounting period. For each day of each week, the input supplied to the Factor Calculation sheet is the total weight in pounds of the shipment received consistent with certain aspects related to the present invention. The sample data discussed above is also entered for the sample day for each week, including the total postage due for the sample and the weight of the sample. The Return delivery charges Weight Averaging System uses this data to calculate a weekly cost factor by dividing the sample dollars by the sample weight.

FIG. 9B shows a completed Factor Calculation Sheet for fiscal year 1, accounting period 2, weeks 4, 5, 6, and 7 consistent with certain aspects related to the present invention. For this example, the business does not receive mail on Saturday or Sunday. For the other days of each week, the weight of mail received is entered into the Factor Calculation sheet. In this case, for week 7 of AP 2, 4700 pounds of mail were received: 800 pounds on Monday, 1100 pounds on Tuesday, 800 pounds on Wednesday, 900 pounds on Thursday and 1100 pounds on Friday. For week 7 of AP 2, on the sample day, $250.00 of postage was due for the sample, which weighed 400 pounds. The weekly factor is calculated by dividing the postage due ($250.00) by the sample weight (400 pounds), for a weekly factor of 0.6250.

The weekly factor is then applied to the total weight for the week (4700 pounds) to reach a total postage due from the customer of $2,937.50. In this way, the postage due can be calculated for each of the four weeks. As shown in FIG. 9B, the business owes $16,294.08 for 22,900 pounds worth of mail. Once data is gathered for four weeks, the 4 week factor is calculated. In this case, the 4 week factor for weeks 4, 5, 6, and 7 of accounting period 2 is 0.7115, which gives a close representation of the profile of the returning mail for this customer.

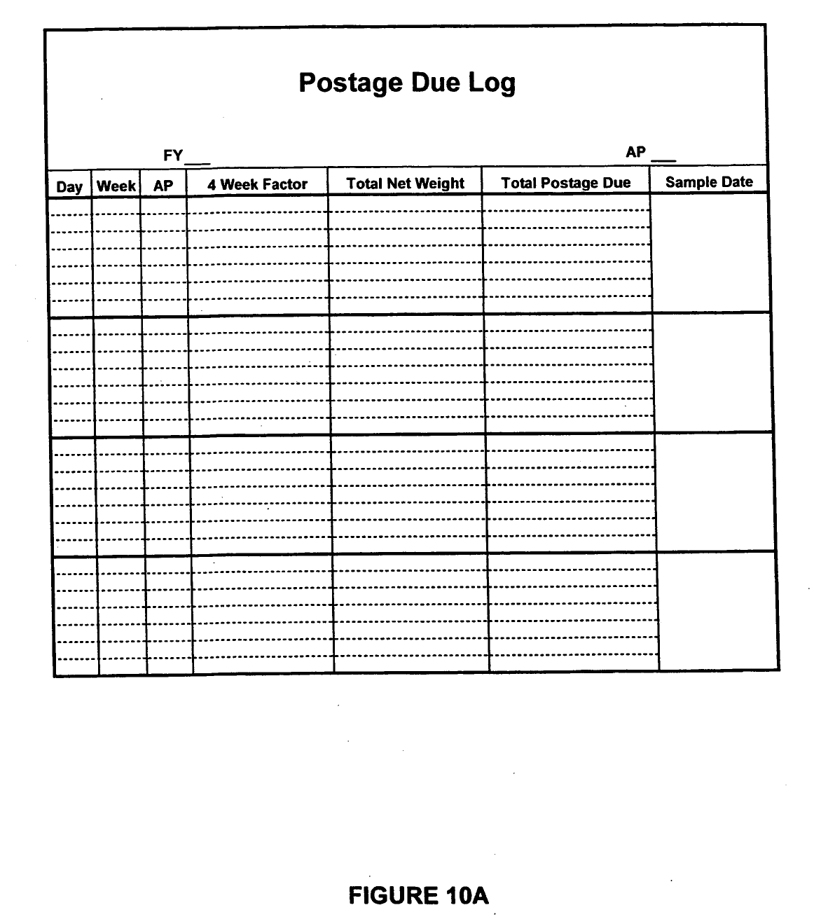

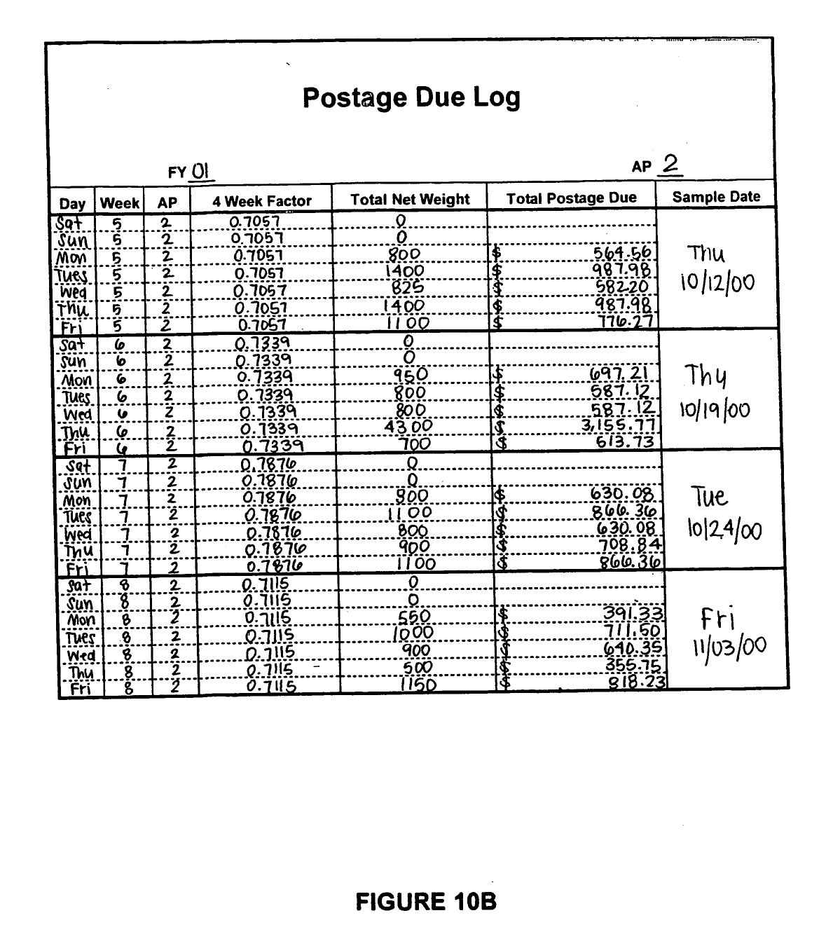

FIG. 10A is a Postage Due Log for the four weeks of the present accounting period, listing the fiscal year (FY) and accounting period (AP) consistent with certain aspects related to the present invention. This log includes the day of the week, the week of the accounting period, the 4 week factor, total net weight, total postage due, and sample date. The 4 week factor is derived from sampling one day per week for four continuous weeks. When the fifth week comes up, the data for the first week will be discarded, creating a rolling factor that is updated weekly. As described above, the 4 week factor is applied against the total net weight for each day's shipment to derive the total postage due for the day. The Postage Due Log also indicates the sample date for each week.

FIG. 10B is a completed Postage Due Log for the hypothetical business in the examples above consistent with certain aspects related to the present invention. Again, the fiscal year is 01 and the accounting period is 2. In the first column are listed the days of the week for four weeks in the accounting period. The 4 week factor is entered, based on the previous 4 weeks. As in the previous examples, no mail is received on Saturday or Sunday, as shown with a zero for the total net weight received. The 4 week factor is static for each particular week and is applied to the total net weight for each day of the week. In this example, on Monday 800 pounds of mail were received, and the total postage due is calculated by multiplying 800 pounds by the 4 week factor of 0.7057. On Tuesday, the same 4 week factor would apply against the 1400 pounds of mail received. For the second week on the Postage Due Log, week 6, new sample data is used to derive a new 4 week factor (0.7339). Like the factor for the previous week, this 4 week factor is applied against the total net weight to derive the total postage due on a daily basis.

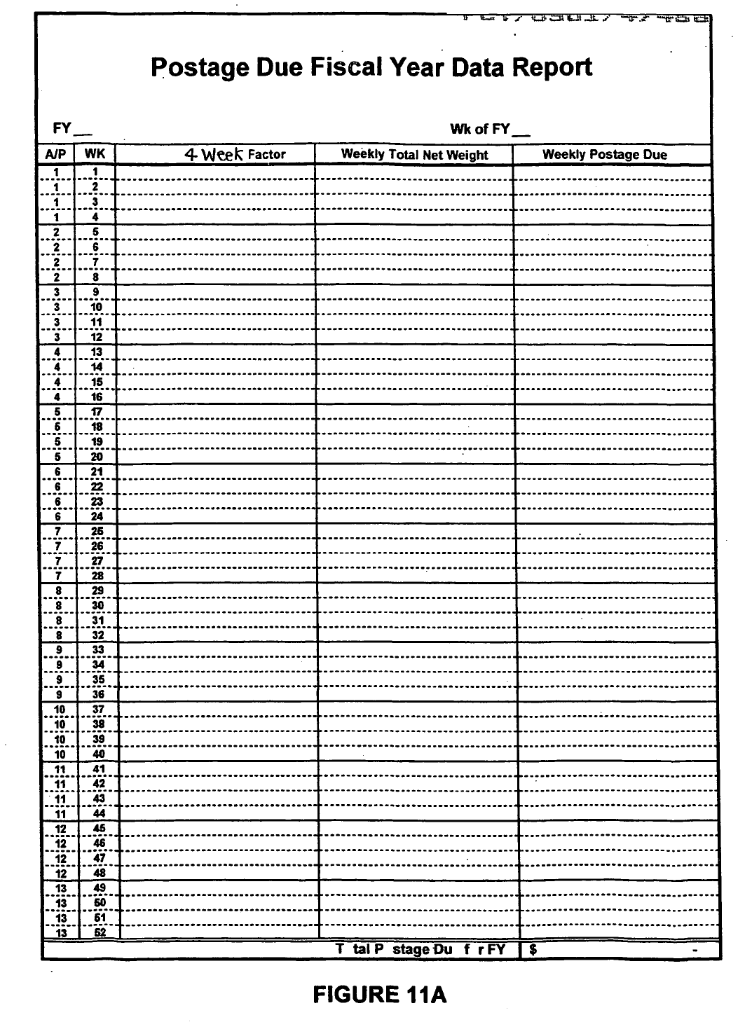

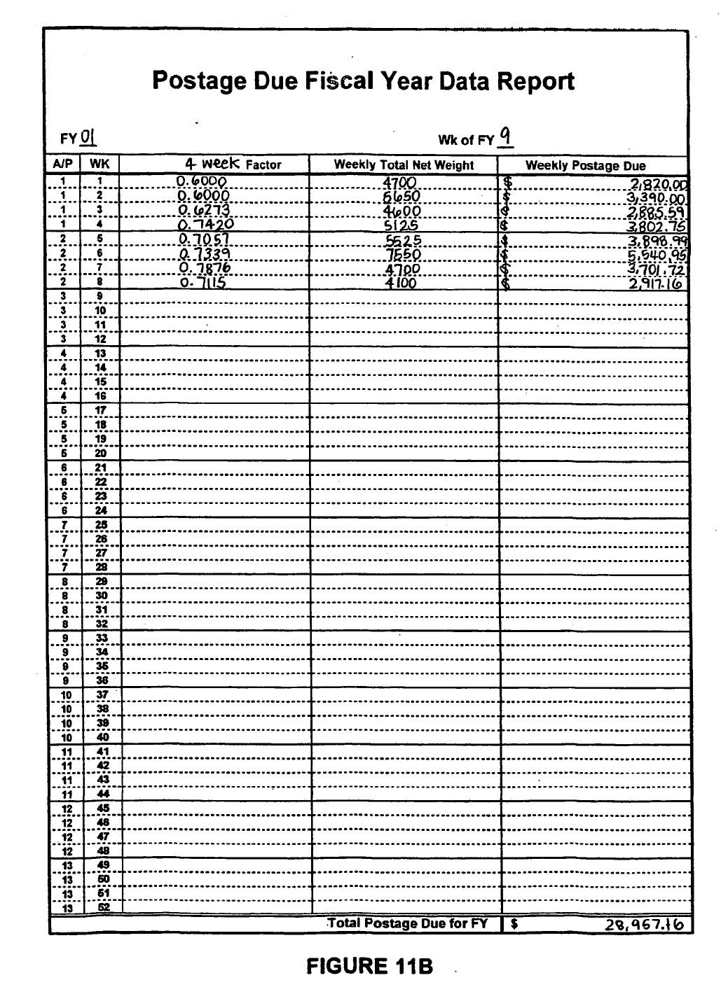

FIG. 11A is a Postage Due Fiscal Year Data Report that compiles information by week within each accounting period for the fiscal year consistent with certain aspects related to the present invention. For each week, the Return delivery charges Weight Averaging System produces the weekly cost factor, weekly total net weight, and weekly postage due. On the Postage Due Fiscal Year Data Report, the total postage due for the fiscal year is shown at the bottom.

FIG. 11B is a completed Postage Due Fiscal Year Data Report showing weeks 1-8 of fiscal year 01 consistent with certain aspects related to the present invention. This shows that, as the mix of items in the delivery items changes, the cost factor adjusts. For instance, if a business one week is shipping out one type of item and then the next week the business is shipping out a slightly heavier or larger item, as the items are returned, the weekly adjustments of the cost factor will reflect the business's mailing patterns. As shown in FIG. 11B, a weekly cost factor is provided for each week. The weekly total net weight shows how many pounds of mail have been returned each week and the weekly postage due shows how much postage has been due each week. The total postage due for the fiscal year is kept as a running total on the Postage Due Fiscal Year Data Report.

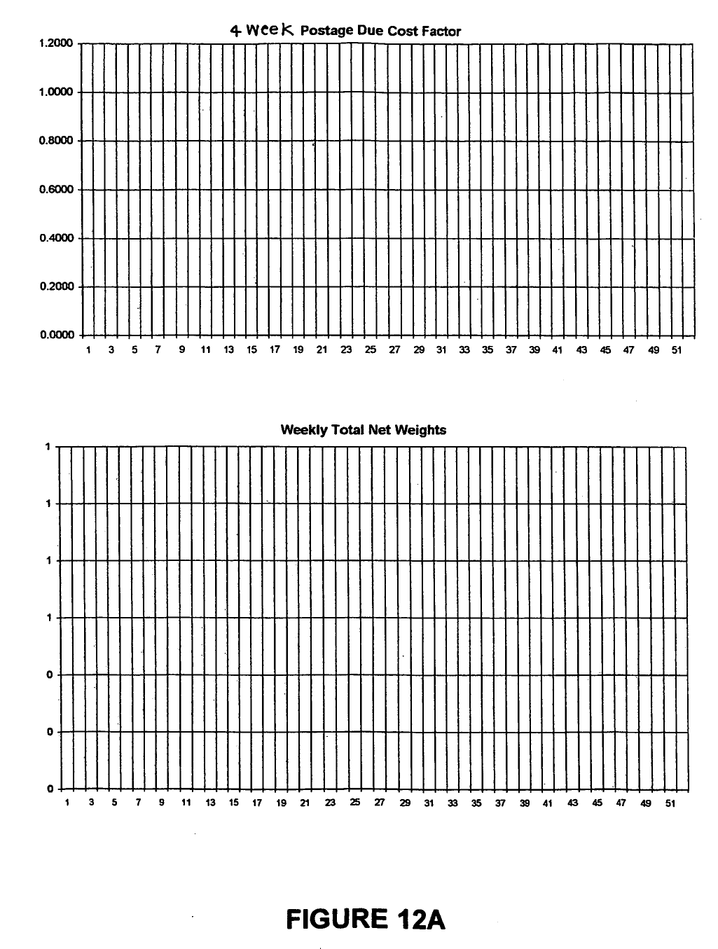

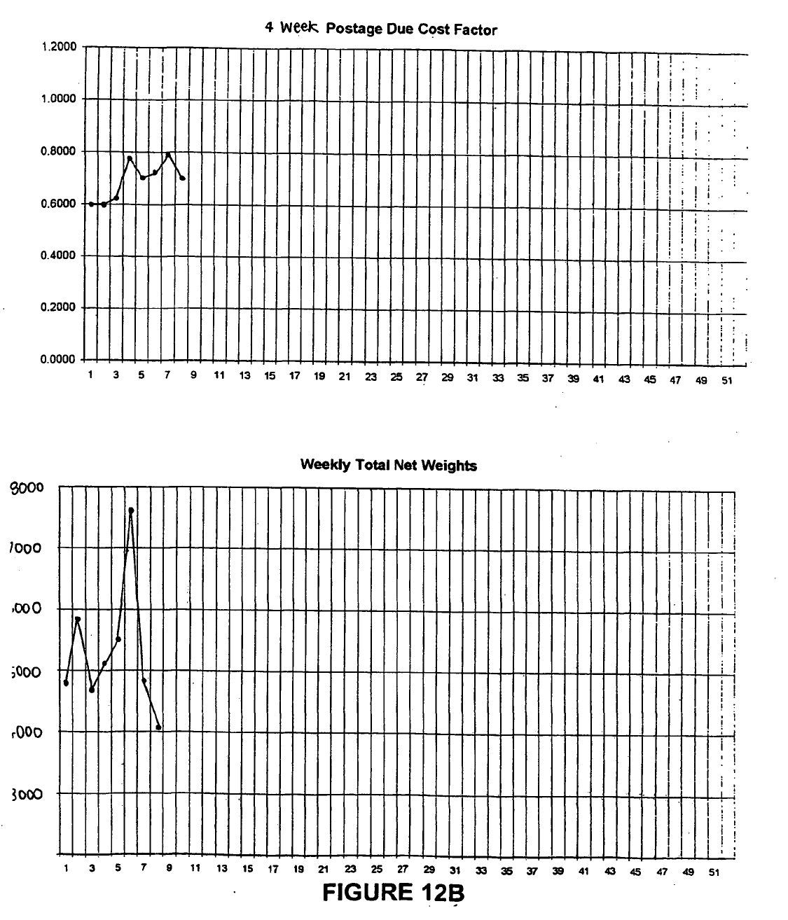

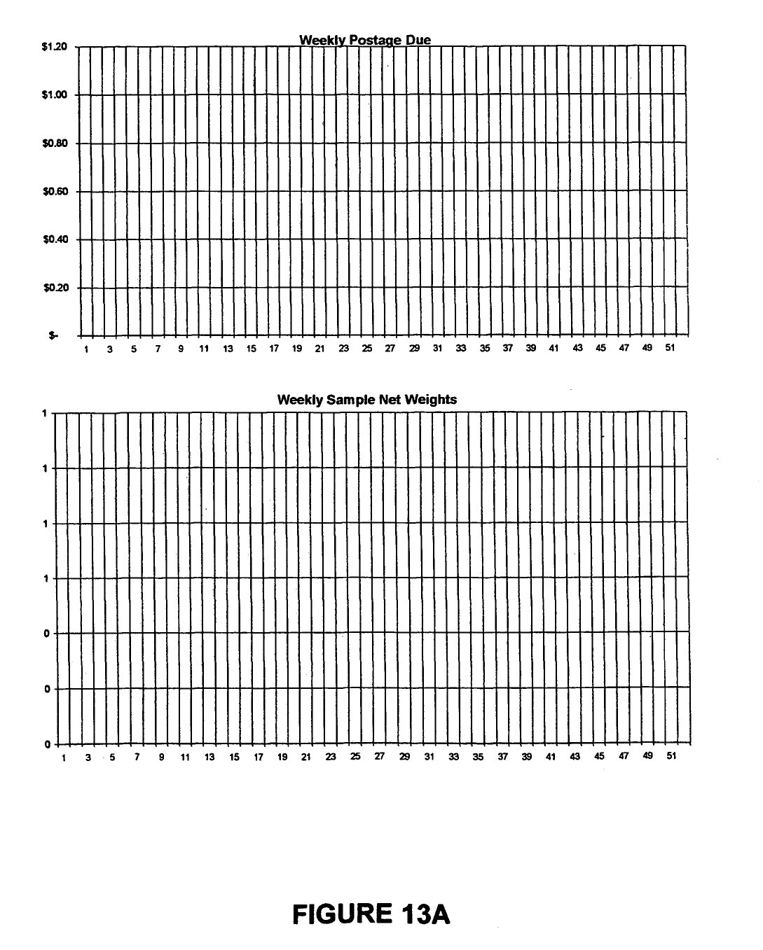

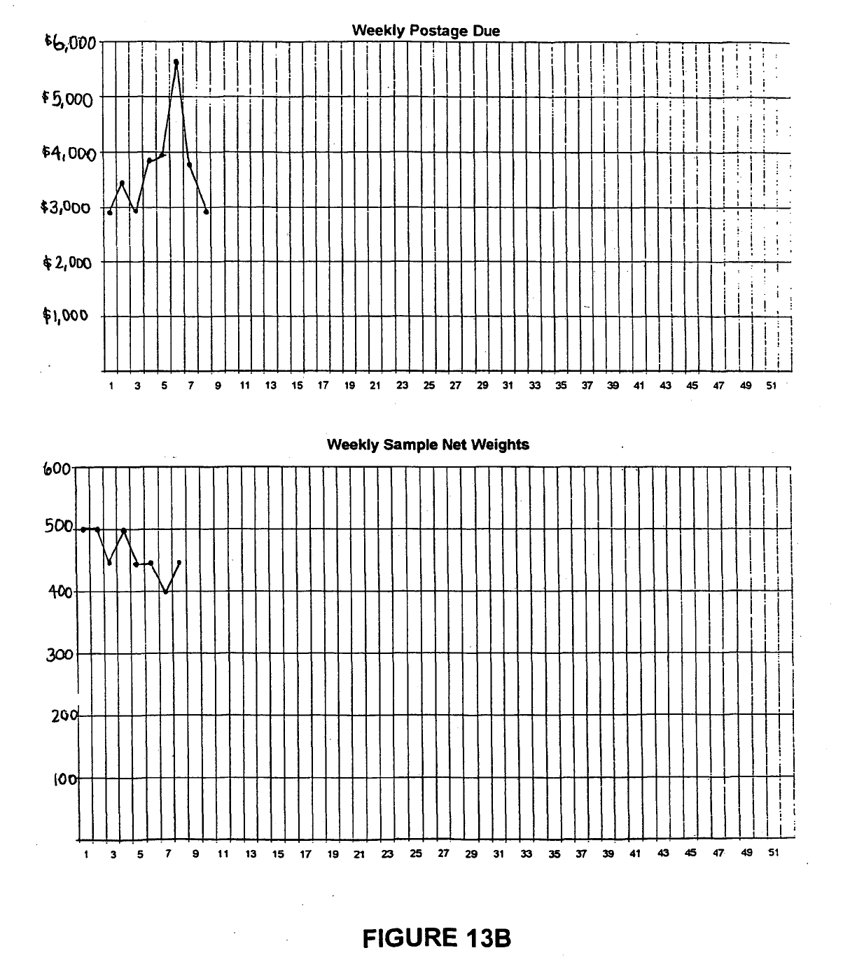

FIG. 12A depict a blank Weekly Postage Due Factor graph and a Weekly Total Net Weights graphs, consistent with certain aspects related to the present invention. FIG. 12B depict a completed example of these graphs consistent with certain aspects related to the present invention. FIG. 13A depicts a black Weekly Postage Due graph and a Weekly Sample Net Weights graph consistent with certain aspects related to the present invention. FIG. 13B depicts a completed example of theses graphs consistent with certain aspects related to the present invention. These reports enable the Return delivery charges Weight Averaging System to graphically present postage due data for a company. The company can track whether the weights significantly varied or the cost factor shifted radically. The company can see quickly whether the sample net weights were static or significantly changing, which can be a correlation to the type of shipping patterns that the business had. These charts can adjust for variations, for example, the factors on the side can float to accommodate significant changes in data.

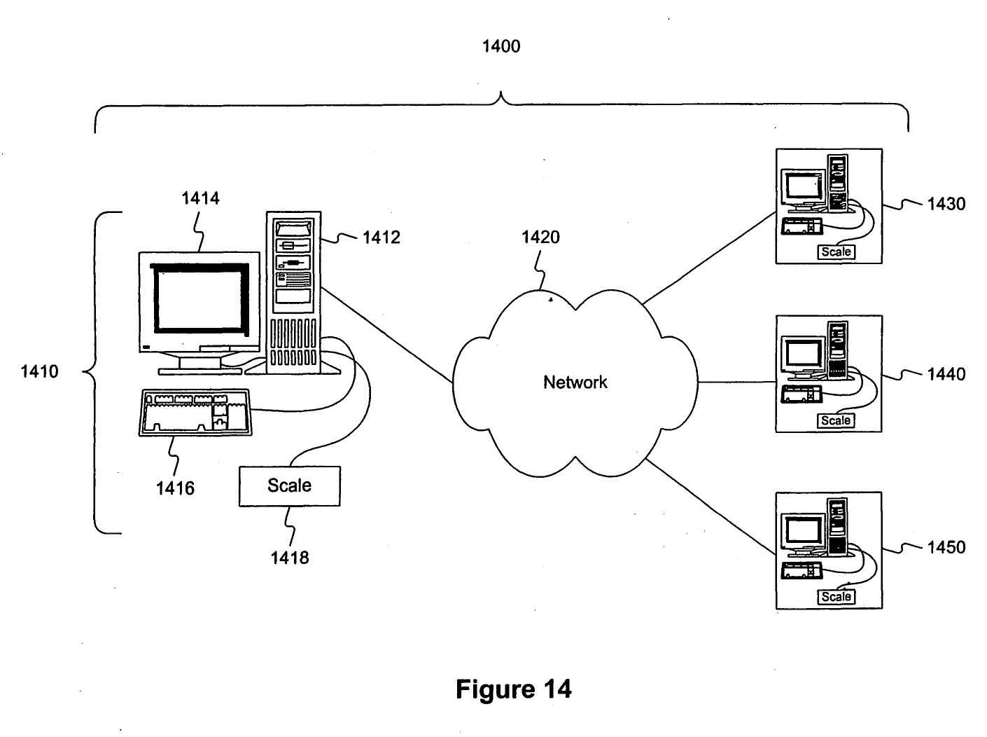

FIG. 14 illustrates an exemplary delivery system 1400 for determining the return delivery charge due for a shipment consistent with certain aspects related to the present invention. System 1400 comprises delivery terminals, such as post offices 1410, 1430, 1440, and 1450. One skilled in the art would realize that postal system 1400 may comprise more post offices than post offices 1410, 1430, 1440, and 1450. Each post office 1410, 1430, 1440, and 1450 includes a computer unit 1412, a display 1414, a input device 1416, and a scale 1418, respectively.

Computer unit 1412 may contain standard components for inputting, outputting, manipulating, and storing data. For example, the computer unit may comprise a central processing unit (CPU), random access memory (RAM), video card, sound card, magnetic storage devices, optical storage devices, input/output (I/O) terminals, and a network interface card (NIC) (all not shown). Computer unit 1412 may optionally be connected to a printer (not shown) through the I/O terminals. Examples of the I/O terminals to which the printer may be connected are parallel, serial, universal serial bus, and IEEE 1394.

Also, computer unit 1412 may be connected to the other computing units through a network 1420. For example, network 1420 may be a local area network (LAN) or wide area network (WAN), such as the Internet, or wireless network.

Post office 1410 also contains a scale 1418. Scale 1418 may be, for example, scale 302 illustrated in FIGS. 3A, 3B, and 3C. Post office 1410 is not limited to one scale but may have multiple scales. Scale 1418 may also be connected to computer unit 1412 though I/O terminals.

Computer unit 1412 may be configured to perform postage due determination. The process may be configured in the form of a process created using various programming languages or software suites. For example, the return delivery charges determination may be a program written in the Java™ programming language, hypertext markup language, or C programming language. In one aspect of the present invention, computer unit 1412 may include a processor (not shown) that executes the return delivery charges determination located in a local or remote memory device (also not shown). One skilled in the art would realize that the configuration of the post office 1410 is exemplary and the present invention is not limited to the examples described above. One skilled in the art would also realize the components of post offices 1430, 1440, and 1450 may be similar to the ones described for post office 1410.

The return delivery charges weight averaging system illustrated in FIG. 5B will now be described as performed on postal system 1400. First, a shipment of items would be received at post office 1410. One skilled in the art would realize that the shipment could be processed at any one of the post offices 1410, 1430, 1440, and 1450. Once the shipment is received, a clerk selects a sample from the shipment and weighs each item from the selected sample on scale 1418 and determine the appropriate rating category for the item. The clerk enters the weight and rating category of each item into computer unit 1412 using input device 1416. The clerk may use forms such as those illustrated in FIGS. 6-11 for selecting samples and entering weights. Also, instead of the clerk entering each weight using input device 1416, the weight may be transferred directly to computer unit 1412 over the I/O terminals (not shown) of computer unit 1412.

Once all the weights and respective categories for the items in sample are entered, computer unit 1412 determines the total sample weight and total sample dollars (stage 504b and 504a). Then, computer unit 1412 determines the RDCCF (stage 506). Computer unit 1412 may use stored programs to perform the determination. Next, a clerk determines the total weight of the shipment using scale 1418 and inputs the total weight into computer unit 1412 (stage 508). Then, computer unit 1412 determines the total return delivery charges for the shipment (stage 510) by multiplying the total shipment weight by the appropriate RDCCF. The total return delivery charges can be displayed on display unit 1414 or printed out on a printer (not shown). The return delivery charges may displayed in graphical forms, such as is illustrated in FIGS. 12A, 12B, 13A, and 13B.

Above, the system illustrated in FIG. 5B was described as being completely performed at post office 1410. However, one skilled in the art would realize any of the stages may be performed at any of post offices 1410, 1430, 1440, and 1450. For example, post office 1430 may perform stage 504, 506, and 508 to determine a RDCCF. The determined RDCCF can then be transferred to post offices 1410, 1440, and 1450. Post offices 1410, 1440, and 1450 may then use the transferred RDCCF to perform stage 510 for shipment at the post offices.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for determining return delivery charges for a shipment of items, comprising:
selecting a portion of the shipment as a sample;
determining a total weight of the items in the sample;
determining a of the return delivery cost of all items in the sample;
determining a cost factor based on the total weight and the total return delivery cost of the sample;
determining a total shipment weight of the shipment; and
applying the cost factor to the total shipment weight to obtain the return delivery charges for the shipment.

2. The method of claim 1, wherein cost factor is calculated based on shipments over a predetermined time period.

3. The method of claim 2, wherein the cost factor is updated on a periodic basis.

4. The method of claim 1, wherein selecting the portion of the shipment comprises selecting the portion at random.

5. The method of claim 1, wherein the sample includes a predetermined minimum of items.

6. The method of claim 1, wherein sample includes all items in the shipment.

7. The method of claim 1, wherein the shipment includes a plurality of types of items, the types including packages, priority mail, and standard parcel post mail.

8. The method of claim 1, wherein determining the cost factor comprises dividing the total sample delivery charges by the total sample weight.

9. The method of claim 1, wherein applying the cost factor comprises multiplying the cost factor by the total shipment weight to obtain the return delivery charges.

10. An apparatus for determining return delivery charges for a shipment of items, comprising:
means for selecting a portion of the shipment as a sample;
means for determining a total weight of the items in the sample;
means for determining a of the return delivery cost of all items in the sample;
means for determining a cost factor based on the total weight and the total return delivery cost of the sample;
means for determining a total shipment weight of the shipment; and
means for applying the cost factor to the total shipment weight to obtain the return delivery charges for the shipment.

11. The apparatus of claim 10, wherein cost factor is calculated based on shipments over a predetermined time period.

12. The apparatus of claim 11, wherein the cost factor is updated on a periodic basis.

13. The apparatus of claim 10 wherein selecting the portion of the shipment comprises selecting the portion at random.

14. The apparatus of claim 10, wherein the sample includes a predetermined minimum of items.

15. The apparatus of claim 10, wherein sample includes all items in the shipment.

16. The apparatus of claim 10, wherein the shipment includes a plurality of types of items, the types including packages, priority mail, and standard parcel post mail.

17. The apparatus of claim 10, wherein the means for determining the cost factor comprises means for dividing the total sample delivery charges by the total sample weight.

18. The apparatus of claim 10, wherein the means for applying the cost factor comprises means for multiplying the cost factor by the total shipment weight to obtain the return delivery charges.

19. A computer readable medium including instructions for performing a method, when executed by a processor, for determining return delivery charges for a shipment of items, the method comprising:
selecting a portion of the shipment as a sample;
determining a total weight of the items in the sample;
determining a of the return delivery cost of all items in the sample;
determining a cost factor based on the total weight and the total return delivery cost of the sample;
determining a total shipment weight of the shipment; and
applying the cost factor to the total shipment weight to obtain the return delivery charges for the shipment.

20. The computer readable medium of claim 19, wherein cost factor is calculated based on shipments over a predetermined time period.

21. The computer readable medium of claim 20, wherein the cost factor is updated on a periodic basis.

22. The computer readable medium of claim 19, wherein selecting the portion of the shipment comprises selecting the portion at random.

23. The computer readable medium of claim 19, wherein the sample includes a predetermined minimum of items.

24. The computer readable medium of claim 19, wherein sample includes all items in the shipment.

25. The computer readable medium of claim 19, wherein the shipment includes a plurality of types of items, the types including packages, priority mail, and standard parcel post mail.

26. The computer readable medium of claim 19, wherein determining the cost factor comprises dividing the total sample delivery charges by the total sample weight.

27. The computer readable medium of claim 19 wherein applying the cost factor comprises multiplying the cost factor by the total shipment weight to obtain the return delivery charges.
